(19) United States
(12) Patent Application Publication
(10) Pub. No.: US 2002/0047690 A1
(43) Pub. Date: Apr. 25, 2002

(54) Power generation control unit for vehicles

(76) Inventors: Nobuhito Okamoto, Chiryu-city (JP); Keiji Takahashi, Kariya-city (JP); Toshinori Maruyama, Anjo-city (JP)

Correspondence Address: LAW OFFICE OF DAVID G POSZ, 2000 L STREET, N.W., SUITE 200, WASHINGTON, DC, 20036, US

(21) Appl. No.: 09/946,822

(22) Filed: Sep. 6, 2001

(30) Foreign Application Priority Data
Sep. 7, 2000 (JP) 2000-272220

(51) Int. Cl. H02P 9/04

(52) U.S. Cl. 322/14

(57) ABSTRACT

An electric power generation control unit for vehicles comprises a transistor, a feedback diode, a voltage control circuit, a load factor signal generating circuit and a load factor signal output limiting circuit. The load factor signal generating circuit outputs a load factor signal synchronized with on/off condition of the transistor. The load factor signal output limiting circuit outputs a signal of a predetermined duty ratio from a load factor signal output terminal even in the condition that the load factor is maximum or minimum.

### CROSS REFERENCE TO RELATED APPLICATION

This application incorporates herein by reference Japanese Patent Application No. 2000-272220 filed on Sep. 7, 2000.

### BACKGROUND OF THE INVENTION

The present invention relates to a power generation control unit for vehicles, which outputs a signal indicating a load factor of an electric power generator to an electronic device such as an engine control unit installed separately.

An electric power generator for vehicle charges a battery and also supplies electric power to various accessory instruments for engine ignition, lighting and other purposes, while a vehicle is running. A power generation control unit is connected to keep a constant output voltage even when the loading condition changes. Recently, a method of utilizing a load factor of the power generator is particularly employed for an external control unit such as an engine control unit or the like to stabilize the idle speed of the engine.

For example, JP-Y-6-19359 discloses an alternating current (AC) power generator control Unit, which can notify a load factor of the power generator to an external electronic device by outputting a field coil voltage signal to the external side of the power generator via a diode from the connecting point between the field coil of the power generator and a voltage control unit (voltage regulator). Use of the diode realizes normal operation of the power generator even when a connecting line or the like for notifying this load factor is shorted to the ground.

Even if the connection line notifying the load factor is in contact with the ground causing a short-circuit in the AC power generator control unit, the power generator can operate normally. However, if such a short-circuit is caused, the notified load factor indicates the full power generation condition or power generation complete stop condition without any relation to the actual load factor. Therefore, there rises a problem that an engine control unit having received such notification of load factor erroneously detects a load factor. Moreover, such a disadvantage also occurs when the connection line for notification is perfectly disconnected from a terminal to output the notification signal of the load factor.

### SUMMARY OF THE INVENTION

The present invention has an object to provide a power generation control unit for vehicles, which can detect a notified defective load factor in a device to which the load factor is notified.

A power generation control unit for vehicles of the present invention comprises a voltage control circuit, a load factor signal generating circuit and a load factor signal output limiting circuit. The voltage control circuit controls an output voltage of the power generator by turning on and off a switching element connected in series to a field coil of the power generator. The load factor signal generating circuit generates a load factor signal indicating the load factor corresponding to the ON/OFF condition of the switching element. When the load factor is near an upper limit value, the load factor signal output limiting circuit outputs, in place of the load factor signal, the upper limit value signal having a first duty ratio corresponding to the upper limit value.

Moreover, the load factor signal output limiting circuit has a function, in place of the function to output the upper limit signal or in addition to this function, to output, in place of the load factor signal, a lower limit value signal having a second duty ratio corresponding to the lower limit value when the load factor is near a lower limit value. Since the upper limit value signal having the first duty ratio and the lower limit value signal having the second duty ratio are outputted in place of the load factor signal when the load factor is near the upper limit value or lower limit value, when the load factor is notified normally, any one of the load factor signal, upper limit value signal and lower limit value signal is outputted. Accordingly, when a connection line notifying the load factor is in contact with the ground or is disconnected perfectly from a terminal to set the duty ratio of the load factor signal to 0 or 100%, this notified defective load factor can be detected with a device to which the load factor is notified.

### BRIEF DESCRIPTION OF THE DRAWINGS

The above and other objects, features and advantages of the present invention will become more apparent from the following detailed description made with reference to the accompanying drawings. In the drawings:

FIG. 1 is an electric circuit diagram illustrating a power generation control unit according to a first embodiment of the present invention;

FIG. 2 is an electric circuit diagram illustrating a power generation control unit according to a second embodiment of the present invention;

FIG. 3 is a signal diagram illustrating an upper limit value signal and a lower limit value signal in the second embodiment; and

FIG. 4 is a graph illustrating a relationship between a duty ratio of a load factor signal and a duty ratio of a signal outputted from a load factor signal output terminal FR.

### DETAILED DESCRIPTION OF THE PREFERRED EMBODIMENTS

[First Embodiment]

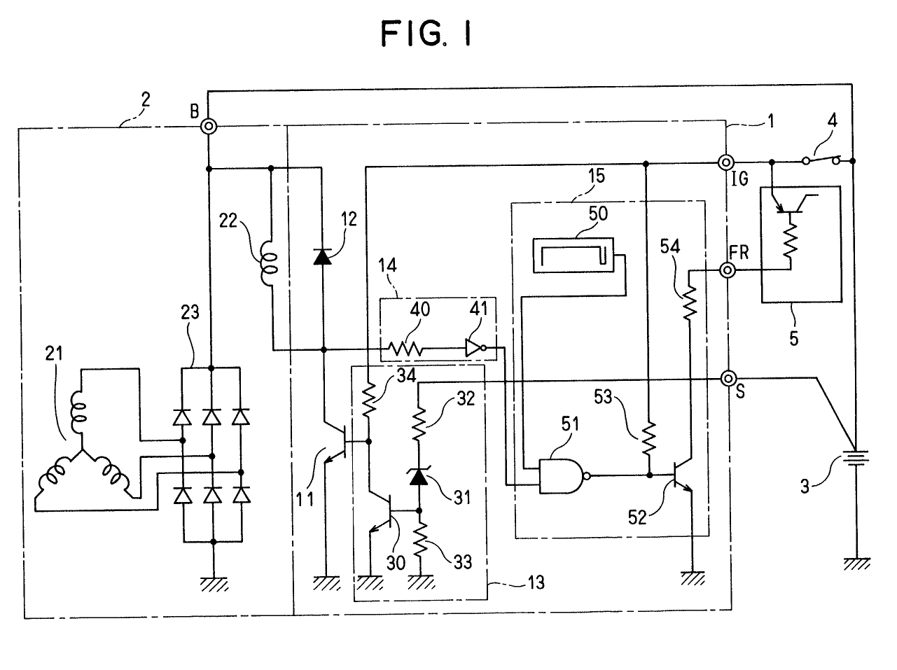

Referring first to FIG. 1, a power generation control unit (voltage regulator) 1 is provided to control the voltage at a terminal S provided to detect the voltage applied to a battery 3 to a predetermined setting value of regulated voltage (for example, 14V). An ignition instruction detecting terminal (IG terminal) is connected to the battery 3 via an ignition switch 4. When the ignition switch 4 is turned on, the control operation of the regulator 1 is started. Moreover, the regulator 1 also includes a load factor signal output terminal (terminal FR) to output a load factor signal to an electronic engine control unit (ECU) 5 provided externally.

A power generator 2 for vehicles comprises a 3-phase stator coils 21 included in a stator (not shown), a rectifying circuit 23 provided for full-wave rectification of the 3-phase output of the stator coil 21 and a field coil 22 included in a rotor (not shown). The output voltage of this power generator 2 is controlled through on/off control of the power feeding to the field coil 22 with the regulator 1. An output terminal (terminal B) of the power generator 2 is connected to the battery 3 and thereby a charging current is supplied to the battery 3 from the terminal B.

The regulator 1 comprises a transistor 11 as a switching element connected in series to the field coil 22, a feedback diode 12 connected in parallel with the field coil 22, a voltage control circuit 13 for instructing on(conductive condition)/off(cut-off condition) of the transistor 11 to set the voltage of terminal S in conjunction with the output voltage of the power generator 2 to the preset value of the regulated voltage, a load factor signal generating circuit 14 for generating the load factor signal based on the voltage generated at the connecting point of the transistor 11 and the field coil 22, and a load factor signal output limiting circuit 15 for generating and outputting an upper limit value signal having a predetermined duty ratio in place of the load factor signal when the load factor is near the upper limit value.

The voltage control circuit 13 is constituted of a transistor 30, a Zener diode 31 and three resistors 32, 33, 34. The Zener diode 31 is selected to have the characteristic with which it breaks when the voltage at the terminal S becomes equal to the preset value of regulated voltage or higher. In this case, the transistor 30 becomes conductive to reduce a collector potential. The collector of transistor 30 is connected to the base of transistor 11. When the collector potential of transistor 30 is lowered, the transistor 11 is cutoff. Therefore, the current flowing into the field coil 22 is also reduced. On the contrary, when the voltage of terminal S is lower than the preset value of the regulated voltage, the transistor 30 is cut off and the transistor 11 becomes conductive. Thereby the current flowing into the field coil 22 is increased.

Moreover, the load factor signal generating circuit 14 is constituted of a resistor 40 and an inverter circuit 41. When the transistor 11 becomes conductive and the power is fed to the field coil 22, a collector potential of transistor 11 becomes low. Therefore a high level signal can be outputted from the inverter circuit 41. On the contrary, when the transistor 11 is cut off and the power is not fed to the field coil 22, the collector potential of transistor 11 becomes high and thereby a low level signal is outputted from the inverter circuit 41. Thus, the load factor signal having the duty ratio depending on the power feeding condition to the field coil 22 is outputted from the load factor signal generating circuit 14.

Moreover, the load factor output limiting circuit 15 is constituted of a PWM (pulse width modulation) circuit 50, a NAND circuit 51, a transistor 52 and tow resistors 53, 54. To one input terminal of the NAND circuit 51, the load factor signal outputted from the load factor signal generating circuit 14 is inputted, while to the other input terminal, the upper limit value signal having the predetermined duty ratio (for example, duty ratio is 95%) outputted from the PWM circuit 50 is inputted. The NAND circuit 51 performs the logical product operation of the load factor signal and upper limit value signal respectively inputted to the two input terminals and also outputs the logically inverted signal as a result of this logical operation. The transistor 52 becomes conductive when the high level signal is outputted from the NAND circuit 51 to output the high level signal from the load factor signal output terminal FR. Moreover, the transistor 52 is cut off when the low level signal is outputted from the NAND circuit 51 and thereby the low level signal is outputted from the load factor signal output terminal FR.

The load factor signal is generated by the load factor signal generating circuit 14 depending on the power feeding condition of the field coil 22, the logical product output of the load factor signal and upper limit value signal can be provided by the load factor signal limiting circuit 15. The on/off condition of the transistor 52 is controlled with the signal which is logically inverted from such logical product output. Accordingly, the signal having the duty ratio almost near the load factor signal can be outputted from the load factor output terminal FR by setting the duty ratio of the upper limit value signal to the value close to 100%.

Moreover, when a heavy electric load is connected to the terminal B of the power generator 2 for vehicle and the voltage at the terminal S becomes lower than the preset value of the regulated voltage for a longer period, the transistor 11 is placed in the complete cut-off condition. In this case, the load factor signal having duty ratio of 100% is outputted from the load factor signal generating circuit 14, but the transistor 52 is controlled to the on/off condition depending on the logical product output of the load factor signal and upper limit value signal. Therefore, the signal having the duty ratio of 95% that is identical to that of the upper limit value signal can be outputted from the load factor output terminal FR.

When the connecting condition of the load factor signal output terminal FR and the condition of the connection line connected to this terminal are normal, the signal having the duty ratio which is almost identical to that of the load factor signal generated in the load factor signal generating circuit 14 is outputted from the load factor signal output terminal FR. Therefore, the engine control unit 5 having received this signal can perform the engine control or the like depending on the load factor of the power generator 2. On the other hand, if in the defective condition where the load factor output terminal FR is disconnected from the connection line or this connection line is broken, the engine control unit 5 receives the signal in the duty ratio of 100%. Therefore such a defective condition can be discriminated from the full-load condition of the power generator 2 in which the signal of the duty ratio of 95% is outputted from the load factor signal output terminal FR.

[Second Embodiment]

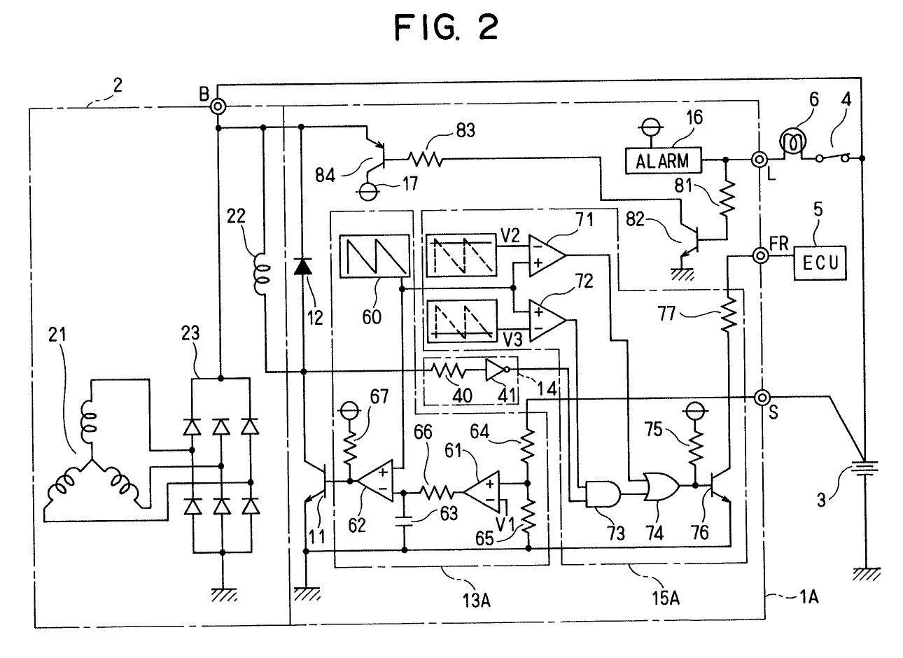

The regulator 1A illustrated in FIG. 2 comprises a transistor 11, a feedback diode 12, a voltage control circuit 13A, a load factor signal generating circuit 14, a load factor signal output limiting circuit 15A, an alarm circuit 16 and a constant voltage source circuit 17.

The voltage control circuit 13A is constituted of a triangular wave generating circuit 60, comparators 61, 62, a capacitor 63 and resistors 64, 65, 66, 67. The voltage at the terminal S is divided with two resistors 64, 65 and the divided voltage is applied to the positive input terminal of the comparator 61. Since a predetermined voltage V1 is applied to the negative input terminal of the comparator 61, the comparator 61 outputs a high level signal when the voltage at the terminal S is higher than the preset value of the regulated voltage. The comparator 61 outputs, on the contrary, a low level signal when the voltage at the terminal S is lower than the preset value of the regulated voltage.

The signal outputted from the comparator 61 is then inputted to the negative input terminal of the comparator 62 via a CR circuit (low pass filter circuit) formed of the capacitor 63 and resistor 66. To the positive input terminal of the comparator 62, a triangular wave signal outputted from the triangular wave generating circuit 60 is inputted. Therefore, the comparator 62 outputs a high level signal when the potential of the signal inputted via the CR circuit is lower than the potential of the triangular wave signal. The comparator 62 outputs, on the contrary, a low level signal when the input signal potential is higher than the triangular wave signal.

Accordingly, when the voltage at the terminal S is higher than the preset value of the regulated voltage, the comparator 61 outputs a high level signal to raise the voltage level of the negative input terminal of the comparator 62. Thereby, the duty ratio of the signal outputted from the comparator 62 gradually becomes lower to make longer the cut-off period of the transistor 11. As a result, a current flowing into the field coil 22 is reduced. On the contrary, when the voltage of terminal S is lower than the preset value of the regulated voltage, the comparator 61 outputs a low level signal to lower the voltage level of the negative input terminal. Thereby, the duty ratio of the signal outputted from the comparator 62 gradually becomes high to make longer the conductive period of transistor 11. As a result, the current flowing into the field coil 22 is increased.

Moreover, the load factor signal output limiting circuit 15A is constituted of two comparators 71, 72, an AND circuit 73, an OR circuit 74, resistors 75, 77, and a transistor 76.

To the positive input terminal of the comparator 71, a triangular wave signal outputted from the triangular wave generating circuit 60 is inputted, while to the negative input terminal, the predetermined voltage V2 is impressed. This comparator 71 generates a lower limit value signal of the predetermined duty ratio (for example, of 5%). Moreover, to the positive input terminal of the comparator 72, the triangular wave signal outputted from the triangular wave generating circuit 60 is inputted, while to the negative input terminal, the predetermined voltage V3 is impressed. This comparator 72 generates the upper limit value signal having the predetermined duty ratio (for example, of 95%).

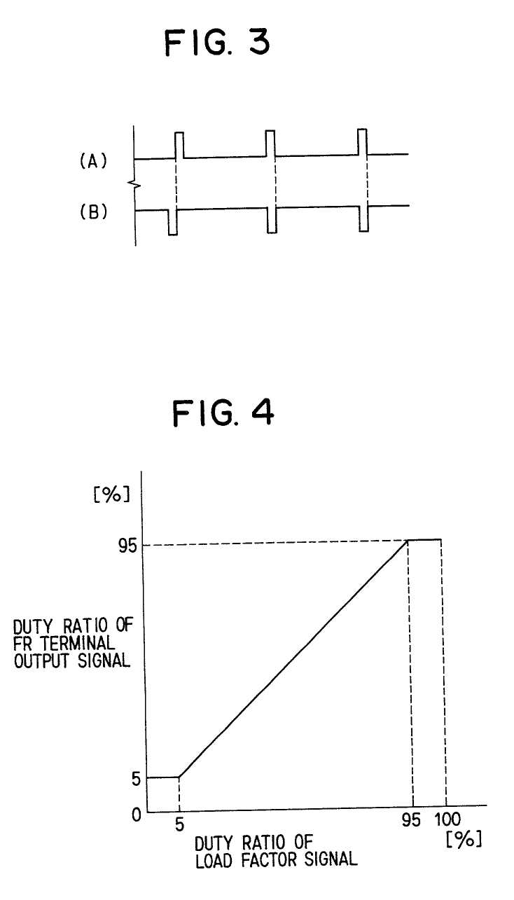

FIG. 3 illustrates the upper limit value signal and lower limit value signal generated by two comparators 71, 72. (A) illustrates the lower limit value signal in the duty ratio of 5%. (B) illustrates the upper limit value signal in the duty ratio of 95%. As illustrated in this FIG. 3. In this embodiment, the timing in which the lower limit value signal becomes the conductive logic is set for mismatching with the timing in which the upper limit value signal becomes the cut-off logic.

The AND circuit 73 allows, at one input terminal, the input of the load factor signal outputted from the load factor generating circuit 14, while at the other input terminal, the input of an upper limit value signal outputted from the comparator 72. Moreover, the OR circuit 74 allows, at one input terminal, the input of the output signal of the AND circuit 73, while at the other input terminal, the lower limit value signal outputted from the comparator 71.

The transistor 76 becomes conductive when a high level signal is outputted from the OR circuit 74 and outputs the low level signal from the load factor signal output terminal FR. Moreover, the transistor 76 is cut off when a low level signal is outputted from the OR circuit 74 and outputs the high level signal from the load factor signal output terminal FR.

When the ignition switch 4 turns on, a base voltage of the transistor 82 connected to the terminal L via a resistor 81 becomes high and the transistor 82 turns on. In this case, the transistor 84 connected to the collector of the transistor 82 via a collector resistor 83 also turns on. Thereby, a constant voltage source circuit 17 starts a voltage feeding operation. Thereby, supply of the operation voltage to an alarm circuit 16 and supply of base currents of the transistors 11, 76 are started. As a result, if any irregular condition does not occur, the alarm circuit 16 raises the voltage of terminal L to extinguish a charge lamp 6 connected to the terminal L.

In addition, when the ignition switch 4 turns on, the power generator 2 starts power generation. Under the ordinary power generating condition, the load factor signal outputted from the load factor signal generating circuit 14 is inputted to the transistor 76 via the AND circuit 73 and OR circuit 74 to control the on/off condition of the transistor 76. Therefore, the signal having the duty ratio which is almost equal to that of the load factor signal can be outputted from the load factor signal output terminal FR by setting the duty ratios of both upper limit value signal and lower limit value signal to the value almost equal to 100%.

Moreover, when a heavy load is connected to the terminal B of the power generator 2 and the voltage of the terminal S is lower than the preset value of regulated voltage for a longer period, the transistor 11 is placed in the complete cut-off condition. In this case, a load factor signal with duty ratio of 100% is outputted from the load factor signal generating circuit 14. However, since the transistor 76 is on/off-controlled depending on the logical product output of the load factor signal and the upper limit value signal, the signal in the duty ratio of 95% which is equal to that of the upper limit value signal is outputted from the load factor signal output terminal FR.

Meanwhile, when the battery 3 is in the fully charged condition, any load is not almost connected to the terminal B of the power generator 2 and the voltage of terminal S is higher than the preset value of the regulated voltage for a longer period, the transistor 11 is placed in the fully conductive condition. In this case, a load factor signal in the duty ratio of 0% is outputted from the load factor signal generating circuit 14. However, since the transistor 76 is on/off-controlled depending on the logical sum output of the load factor signal and lower limit value signal, the signal in the duty ratio of 5% which is equal to that of the lower limit value signal is outputted from the load factor signal output terminal FR.

FIG. 4 illustrates a relationship between the duty ratio of load factor signal and the duty ratio of the signal outputted from the load factor signal output terminal FR. When the load factor is almost equal to 0%, the duty ratio of the signal outputted from the load factor signal output terminal FR is fixed to 5%. When the load factor is almost equal to 100%, on the contrary, the duty ratio of the signal outputted from the load factor signal output terminal FR is fixed to 95%.

When the connecting condition of the load factor output terminal FR and the condition of connection line connected to this terminal are normal, since the signal in the duty ration which is almost equal to that of the load factor signal generated in the load factor signal generating circuit 14 is outputted from the load factor signal output terminal FR, the engine control unit 5 having received this signal can control the engine depending on the load factor of the power generator 2.

On the other hand, in the irregular condition that the connection line is disconnected from the load factor signal output terminal FR and the connection line is broken, the engine control unit 5 receives the signal in the duty ratio of 100%. Accordingly, this irregular condition can be discriminated from the full-load condition of the power generator 2 in which the signal in the duty ratio of 95% is outputted from the load factor output terminal FR. Moreover, in the irregular condition that the load factor signal output terminal FR or the connection line connected to this terminal is shorted to the ground, since the engine control unit 5 receives the signal in the duty ratio of 0%, this condition is discriminated from the non-load condition of the power generator 2 in which the signal in the duty ratio of 5% is outputted from the load factor signal output terminal FR.

The present invention is not limited only to the embodiments explained above and allows various changes or modifications.

For example, in the embodiments, a circuit for sending the signal to the load factor signal output terminal FR is provided between the terminal FR and the ground, but it is also possible that the load factor signal is sent from the terminal of the field coil 22 via the resistor 40 for current limitation and a composite voltage with the logic signal which is on/off-controlled with a predetermined PWM duty value is outputted from the load factor signal output terminal FR.

Moreover, an alarm signal to be outputted to the external side can be sent to the external circuit by setting the duty ratio of the load factor signal to 0%.

What is claimed is:

1. A control unit for a power generator of a vehicle having a field coil, the control unit comprising:
a switching element connected in series with the field coil of the power generator;
a voltage control circuit for controlling an output voltage of the power generator by controlling on/off of the switching element;
a load factor signal generating circuit for generating a load factor signal indicating a load factor corresponding to an on/off condition of the switching element; and
a load factor signal output limiting circuit for outputting, in place of the load factor signal, an upper limit value signal in a fixed duty ratio corresponding to an upper limit value when the load factor is near the upper limit value.

2. The control unit according to claim 1, wherein the load factor signal output limiting circuit outputs, in place of the load factor signal, a lower limit value signal of another fixed duty ratio corresponding to a lower limit value when the load factor is near the lower limit value.

3. The control unit according to claim 1, wherein the fixed duty ratio is set at about 95%.

4. The control unit according to claim 2, wherein the another fixed duty ratio is set at about 5%.

5. The control unit according to claim 1, wherein the upper limit value signal is synchronized with an on/off period of the switching element.

6. The control unit according to claim 1, further comprising:
an alarm circuit for outputting an alarm signal to the an external circuit by detecting a fault of the power generator during operation of the voltage control circuit,
wherein a fault is notified outside depending on an output condition of the load factor signal output limiting circuit, when supply of power source voltage fails resulting in a non-operating condition of the alarm circuit.

7. A control unit for a power generator of a vehicle having a field coil, the control unit comprising:
a switching element connected in series with the field coil of the power generator;
a voltage control circuit for controlling an output voltage of the power generator by controlling on/off of the switching element;
a load factor signal generating circuit for generating a load factor signal indicating a load factor corresponding to an on/off condition of the switching element; and
a load factor signal output limiting circuit for outputting, in place of the load factor signal, a lower limit value signal of a fixed duty ratio corresponding to a lower limit value when the load factor is near the lower limit value.

8. The control unit according to claim 7, wherein the fixed duty ratio is set at about 5%.

9. The control unit according to claim 7, wherein the upper limit value signal is synchronized with an on/off period of the switching element.

10. The control unit according to claim 7, further comprising:
an alarm circuit for outputting an alarm signal to the an external circuit by detecting a fault of the power generator during operation of the voltage control circuit,
wherein a fault is notified outside depending on an output condition of the load factor signal output limiting circuit, when supply of power source voltage fails resulting in a non-operating condition of the alarm circuit.
